(19) United States
(12) Patent Application Publication
(10) Pub. No.: US 2017/0289663 A1
(43) Pub. Date: Oct. 5, 2017

(54) ELECTRONIC DEVICE AND CONTROL METHOD USING AUDIO COMPONENTS THEREOF

(71) Applicant: Samsung Electronics Co., Ltd., Gyeonggi-do (KR)

(72) Inventors: Myungcheol LEE, Gyeonggi-do (KR); Byounghee Lee, Seoul (KR); Youngbae PARK, Seoul (KR); Sunyoung LEE, Gyeonggi-do (KR); Changshik YOON, Seoul (KR); Joonrae CHO, Seoul (KR); Hochul HWANG, Gyeonggi-do (KR)

(21) Appl. No.: 15/478,764

(22) Filed: Apr. 4, 2017

(30) Foreign Application Priority Data
Apr. 5, 2016 (KR) 10-2016-0041374

(51) Int. Cl. H04R 1/02; H04N 5/232; G06F 3/043

(52) U.S. Cl. CPC H04R 1/028; G06F 3/0433; H04N 5/23245; H04R 2499/11

(57) ABSTRACT

An electronic device and a method of controlling the electronic device using audio components are provided. The electronic device includes a transducer, and a processor that detects a touch of an external object which is related to the transducer, and executes a function, based on the touch.

### PRIORITY

This application claims priority under 35 U.S.C. §119(a) to Korean Patent Application No. 10-2016-0041374 filed in the Korean Intellectual Property Office on Apr. 5, 2016, which is incorporated herein by reference.

### BACKGROUND

### 1. Field of the Disclosure

The present disclosure relates generally to an electronic device and a method of controlling the electronic device using audio components (i.e., transducers) of the electronic device.

### 2. Description of Related Art

With the development of electronic technology, electronic devices have been developed to provide users with various types of multimedia-related services, such as music, video, digital broadcast, etc., as well as voice and video call services. In order to provide such services, electronic devices may be configured to include various transducers, e.g., a speaker, a receiver, earphones, a microphone, etc.

The transducers are disposed adjacent to an opening formed in one side of the housing of electronic devices so that they can efficiently receive/output audio signals from/to the outside.

As such, existing transducers are only used for the input or output of audio signals; however, they have not been used to control electronic devices.

### SUMMARY

The present disclosure has been made to address the above-mentioned problems and disadvantages, and to provide at least the advantages described below.

Accordingly, an aspect of the present disclosure is to provide an electronic device and a method of controlling the electronic device using components (i.e., transducers) used for the input or output of audio signals.

Accordingly, another aspect of the present disclosure is to use transducers included in an electronic device to control the electronic device without requiring other devices (e.g., an input unit or a sensor).

Accordingly, another aspect of the present disclosure is to intuitively use transducers to perform functions of an electronic device, thereby eliminating complicated, redundant operations.

Accordingly, another aspect of the present disclosure is to reduce the installation space required for the components of an electronic device.

In accordance with an aspect of the present disclosure, an electronic device is provided. The electronic device includes a transducer, and a processor that detects a touch of an external object which is related to the transducer, and executes a function, based on the touch.

In accordance with another aspect of the present disclosure, an electronic device is provided. The electronic device includes a first transducer, a second transducer, and a processor that detects a touch of an external object which is related to at least one of the first transducer and the second transducer, performs a first preset function when the touch is related to only the first transducer, and performs a second preset function when the touch is related only to the second transducer.

In accordance with another aspect of the present disclosure, an electronic device is provided. The electronic device includes a first transducer, a second transducer, and a processor that obtains a first audio signal via the first transducer, obtains a second audio signal via the second transducer, detects a level of the first audio signal, detects a level of the second audio signal, performs a first preset function when a level difference between the level of the first audio signal and the level of the second audio signal is within a first preset range of levels, and performs a second preset function if the level difference is within a second preset range of levels.

In according with another aspect of the present disclosure, a method of controlling an electronic device is provided. The method includes detecting a touch of an external object which is related to at least one of a first transducer and a second transducer of the electronic device, performing a first preset function when the touch is related to only the first transducer, and performing a second preset function when the touch is related only to the second transducer.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram of a network environment including an electronic device, according to an embodiment of the present disclosure;

FIG. 2 is a block diagram of a configuration of an electronic device, according to an embodiment of the present disclosure;

FIG. 3 is a block diagram of a configuration of a program module, according to an embodiment of the present disclosure;

FIG. 4 is a flowchart of a method of controlling an electronic device using a transducer of an electronic device, according to an embodiment of the present disclosure;

FIG. 5 is a flowchart of a method of controlling an electronic device using an audio output transducer of an electronic device, according to an embodiment of the present disclosure;

FIGS. 6A to 6C illustrate a method of touching an opening disposed adjacent to an audio output transducer of an electronic device, according to an embodiment of the present disclosure;

FIG. 7 is a graph illustrating a change of impedance when a touch is applied to an opening disposed adjacent to an audio output transducer of an electronic device, according to an embodiment of the present disclosure;

FIG. 8 is a flowchart of a method of controlling an electronic device using an audio input transducer of an electronic device, according to an embodiment of the present disclosure;

FIG. 9 illustrates a method of touching an opening disposed adjacent to an audio input transducer of an electronic device, according to an embodiment of the present disclosure;

FIG. 10 is a graph illustrating a change in an audio input signal created when a touch is applied to or removed from an opening disposed adjacent to an audio input transducer of an electronic device, according to an embodiment of the present disclosure;

FIGS. 11 and 12 are graphs illustrating a change in an audio input signal created when a touch is applied to or removed from an opening disposed adjacent to an audio input transducer of an electronic device in various environments, according to an embodiment of the present disclosure;

FIG. 13 is a flowchart of a method of controlling an electronic device including at least two transducers, according to an embodiment of the present disclosure;

FIG. 14 illustrates a method of simultaneously touching first and second transducers of an electronic device, according to an embodiment of the present disclosure; and

FIG. 15 is a flowchart of a method of controlling an electronic device using a level difference between at least two transducers of an electronic device, according to an embodiment of the present disclosure.

### DETAILED DESCRIPTION OF EMBODIMENTS OF THE DISCLOSURE

Hereinafter, various embodiments of the present specification will be described with reference to the accompanying drawings, in which like reference numerals are used to refer similar elements. However, it should be understood that there is no intent to limit the present disclosure to the particular forms disclosed herein. Rather, the present disclosure should be construed to cover various modifications, equivalents, and/or alternatives of embodiments of the present disclosure. As used herein, the expressions “have” and “include” refer to the existence of a corresponding feature (e.g., a numeral, a function, an operation, an element, component, etc.), and do not exclude one or more additional features.

In the present disclosure, the expressions “A or B”, “at least one of A or/and B”, and “one or more of A or/and B” may include all possible combinations of the items listed. For example, the expressions “A or B”, “at least one of A and B”, and “at least one of A or B” refer to all of (1) A, (2) B, or (3) A and B.

The expressions “first”, “second”, etc. used herein may modify various components regardless of the order and/or the importance, but do not limit the corresponding components. For example, a first user device and a second user device indicate different user devices although both of them are user devices. For example, a first element may be referred to as a second element, and similarly, a second element may be referred to as a first element without departing from the scope of the present disclosure.

It should be understood that when an element (e.g., a first element) is referred to as being “connected,” or “coupled,” to another element (e.g., a second element), the element may be directly connected or coupled directly to the other element or any other element (e.g., a third element) may be interposed between them. In contrast, it may be understood that when an element (e.g., a first element) is referred to as being “directly connected,” or “directly coupled” to another element (e.g., a second element), there are no element (e.g., a third element) interposed between them.

The expression “configured to” used in the present disclosure may be used interchangeable with the expressions “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms used in the present disclosure are only used to describe specific embodiments, and are not intended to limit the present disclosure. As used herein, singular forms may include plural forms as well, unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equivalent to the contextual meanings in the relevant field of art, and are not to be interpreted to have ideal or excessively formal meanings unless clearly so defined in the present disclosure. In some cases, even a term defined in the present disclosure should not be interpreted to exclude embodiments of the present disclosure.

An electronic device, according to various embodiments of the present disclosure, may be a device that involves a communication function. For example, the electronic device may be a smart phone, a tablet personal computer (PC), a mobile phone, a video phone, an e-book reader, a desktop PC, a laptop PC, a netbook computer, a personal digital assistant (PDA), a portable multimedia player (PMP), an MP3 player, a portable medical device, a digital camera, or a wearable device (e.g., a head-mounted device (HMD), such as electronic glasses, electronic clothes, an electronic bracelet, an electronic necklace, an electronic accessory, an electronic tattoo, a smart mirror, or a smart watch).

According to some embodiments, the electronic device may be a smart home appliance that involves a communication function. For example, the electronic device may be a television (TV), a digital versatile disk (DVD) player, an audio equipment, a refrigerator, an air conditioner, a vacuum cleaner, an oven, a microwave, a washing machine, an air cleaner, a set-top box, a TV box (e.g., Samsung HomeSync™, Apple TV™, Google TV™, etc.), a game console, an electronic dictionary, an electronic key, a camcorder, or an electronic picture frame.

According to another embodiment, the electronic device may be a medical device (e.g., a portable medical measuring device (e.g., a blood glucose monitoring device, a heart rate monitoring device, a blood pressure measuring device, a body temperature measuring device, etc.), a magnetic resonance angiography (MRA), a magnetic resonance imaging (MRI), a computed tomography (CT) machine, and an ultrasonic machine), a navigation device, a global positioning system (GPS) receiver, an event data recorder (EDR), a flight data recorder (FDR), a vehicle infotainment device, an electronic device for a ship (e.g., a navigation device for a ship, and a gyro-compass), an avionics device, a security device, an automotive head unit, a robot, an automatic teller machine (ATM), a point of sales (POS) device, or an Internet of things (IoT) device (e.g., a light bulb, a sensor, an electric or gas meter, a sprinkler device, a fire alarm, a thermostat, a streetlamp, a toaster, a sporting goods, a hot water tank, a heater, a boiler, etc.)

According to some embodiments, the electronic device may be furniture or part of a building or construction having a communication function, an electronic board, an electronic signature receiving device, a projector, or a measuring instrument (e.g., a water meter, an electric meter, a gas meter, a wave meter, etc.).

According to an embodiment, the electronic device may be a flexible device.

The electronic device disclosed herein may be one of the above-mentioned devices or any combination thereof As should be understood by those skilled in the art, the above-mentioned electronic devices are provided for illustration purposes only and are not intended to limit the scope of the present disclosure.

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

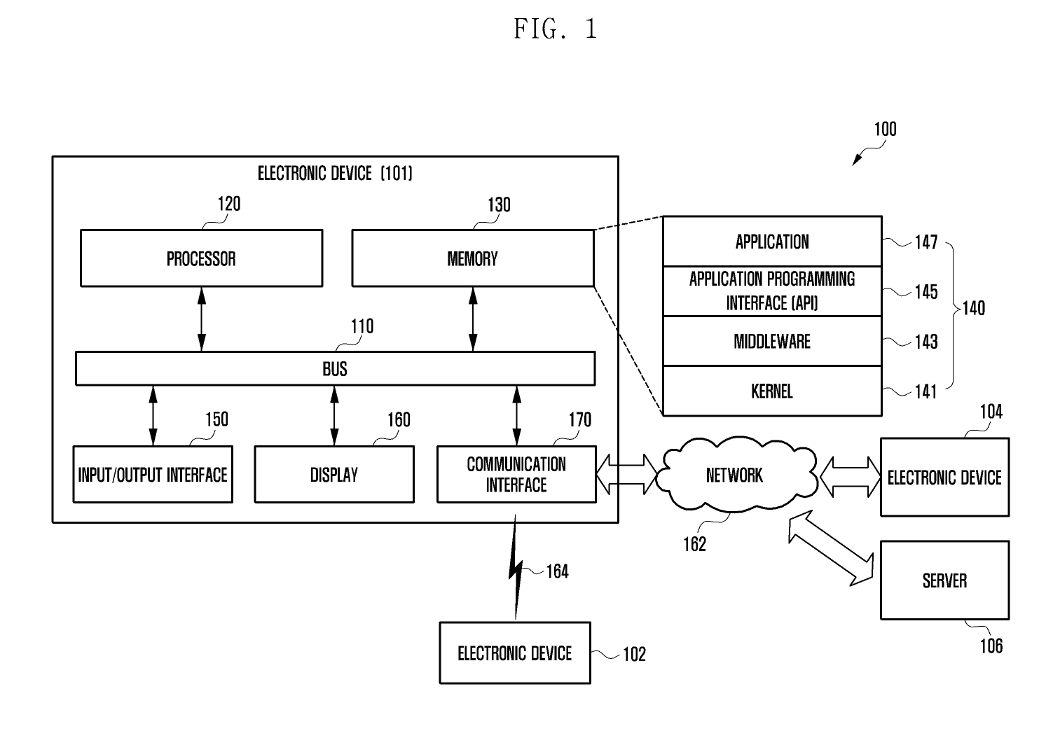

FIG. 1 is a block diagram of a network environment including an electronic device, according to an embodiment of the present disclosure.

Referring to FIG. 1, an electronic device 101, in a network environment 100, is provided. The electronic device 101 includes a bus 110, a processor 120, a memory 130, an input/output interface 150, a display 160, and a communication interface 170. According to some embodiments, the electronic device 101 may omit at least one of the components or further include another component.

The bus 110 may be a circuit connecting the above described components of the electronic device 101 and transmitting communication (e.g., a control message) between the above described components.

The processor 120 may include one or more of a CPU, an AP or a communication processor (CP). For example, the processor 120 may control at least one component of the electronic device 101 and/or execute calculations relating to communication or data processing.

The memory 130 may include volatile and/or non-volatile memory. For example, the memory 130 may store a command or data relating to at least one component of the electronic device 101. The memory may store software and/or programs 140. For example, the programs 140 may include a kernel 141, middleware 143, an application programming interface (API) 145, and/or an application 147. At least one portion of the kernel 141, the middleware 143 and the API 145 may be defined as operating system (OS).

The kernel 141 controls or manages system resources (e.g., the bus 110, the processor 120, or the memory 130) used for executing an operation or function implemented by the remaining programs, for example, the middleware 143, the API 145, or the application 147. Further, the kernel 141 provides an interface for accessing individual components of the electronic device 101 from the middleware 143, the API 145, or the application 147 to control or manage the components.

The middleware 143 performs a relay function of allowing the API 145 or the application 147 to communicate with the kernel 141 to exchange data. Further, in operation requests received from the application 147, the middleware 143 performs a control for the operation requests (e.g., scheduling or load balancing) by using a method of assigning a priority to the application 147, by which system resources (e.g., the bus 110, the processor 120, the memory 130 and the like) of the electronic device 101 may be used.

The API 145 is an interface by which the application 147 may control a function provided by the kernel 141 or the middleware 142 and includes at least one interface or function (e.g., command) for file control, window control, image processing, or character control.

The input/output interface 150 is an interface to transmit a command or data inputted by a user or another external device to another component of the electronic device 101. Further, the input/output interface 150 may output the command or data received from the other component of the electronic device 101 to the user or the other external device.

The display 160 may include a liquid crystal display (LCD), a light emitting diode (LED), an organic LED (OLED), a micro electro mechanical system (MEMS) display, or an electronic paper display. The display 160 may display various contents (e.g., text, image, video, icon, or symbol, etc.) to a user. The display 160 may include a touch screen, and receive touch, gesture, approaching, or hovering input using a part of body of the user.

The communication interface 170 establishes communication between the electronic device 101 and a first external electronic device 102, a second external electronic device 104, or a server 106. For example, the communication interface 170 may communicate with the first external electronic device 102 via short-range communication 164 and may be connected with a network 162 through wireless communication or wire communication and communicate with the second external electronic device 104 or the server 106.

Wireless communication may use, as a cellular communication protocol, at least one of long-term evolution (LTE), LTE advance (LTE-A), code division multiple access (CDMA), wideband CDMA (WCDMA), universal mobile telecommunications system (UMTS), wireless broadband (WiBro), and global system for mobile communication (GSM). The short-range communication 164 may include at least one of Wi-Fi, Bluetooth (BT), near field communication (NFC), magnetic secure transmission (MST), and global navigation satellite system (GNSS), and the like. The GNSS may include at least one of a GPS, a global navigation satellite system (Glonass), a Beidou navigation satellite system (Beidou), and Galileo (the European global satellite-based navigation system). Hereinafter, the term “GPS” may be interchangeably used with the term “GNSS”.

Wired communication may include at least one of universal serial bus (USB), high definition multimedia interface (HDMI), recommended standard-232 (RS-232), and plain old telephone service (POTS), and the like.

The network 162 may include a telecommunication network, for example, at least one of a computer network (e.g., a local area network (LAN) or a wide-area network (WAN)), the internet, and a telephone network.

Each of the first external electronic device 102 and the second external electronic device 104 may be the same type or different type of device as the electronic device 101. The server 106 may include one or more groups of servers. According to various embodiments, at least one portion of executions executed by the electronic device 101 may be performed by one or more external devices (e.g., the first external electronic device 102, the second external electronic device 104, or the server 106). In this case, when the electronic device 101 should perform a function or service automatically, the electronic device 101 may request that at least one function be performed by the first external electronic device 102, the second external electronic device 104, or the server 106. For the above, cloud computing technology, distributed computing technology, or client-server computing technology may be used.

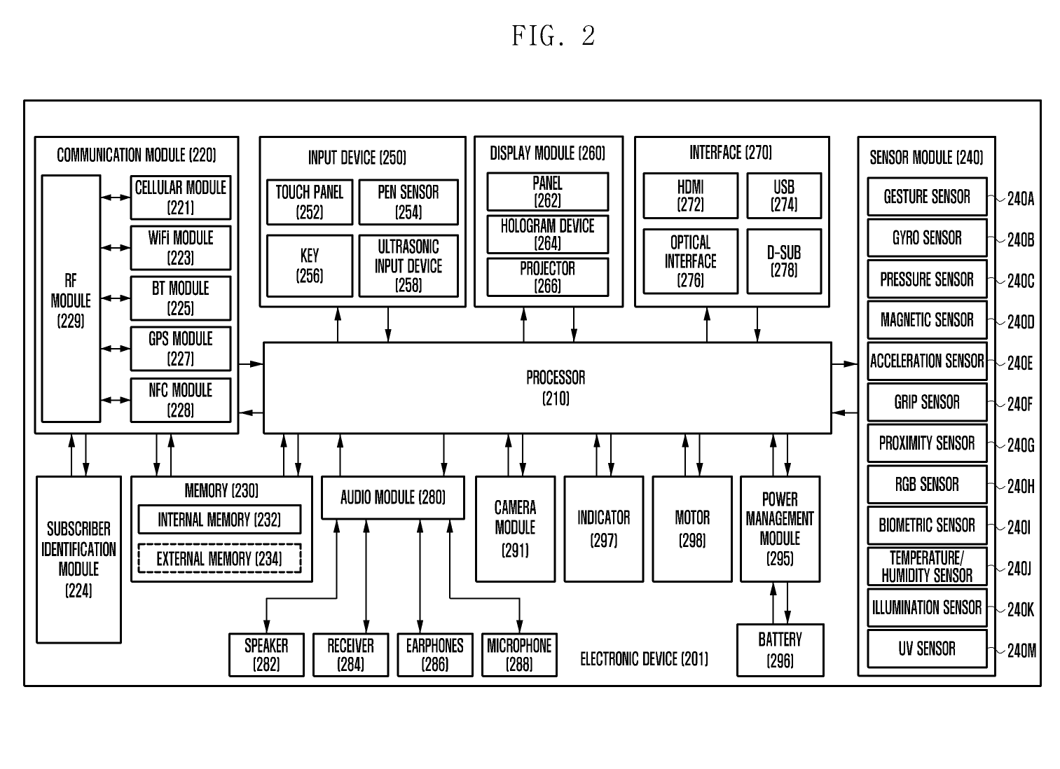

FIG. 2 is a block diagram of a configuration of an electronic device, according to an embodiment of the present disclosure.

Referring to FIG. 2, an electronic device 201 is provided. The electronic device 201 includes at least one processor 210, a communication module 220, a subscriber identification module (SIM) 224, a memory 230, a sensor module 240, an input device 250, a display module 260, an interface 270, an audio module 280, a camera module 291, a power managing module 295, a battery 296, an indicator 297, and a motor 298.

The processor 210 operates an OS or an AP so as to control a plurality of hardware or software component elements connected to the processor 210 and execute various data processing and calculations including multimedia data. The processor 210 may be implemented by, for example, a system on chip (SoC). The processor 210 may further include a graphics processing unit (GPU) and/or an image signal processor (ISP). The processor 210 may include at least a portion of the components of the electronic device 201 (e.g., a cellular module 221). The processor 210 may load a command or data received from another component of the electronic device 201 (e.g., non-volatile memory), and store various data in the non-volatile memory.

The communication module 220 includes the cellular module 221, a Wi-Fi module 223, a BT module 225, a GPS module 227, a NFC module 228, and a radio frequency (RF) module 229.

The cellular module 221 provides a voice call, a video call, a short message service (SMS), or an internet service through a communication network (e.g., LTE, LTE-A, CDMA, WCDMA, UMTS, WiBro, GSM and the like). Further, the cellular module 221 may distinguish and authenticate electronic devices within a communication network by using the SIM 224. The cellular module 221 may perform at least some of the functions which may be provided by the processor 210. For example, the cellular module 221 may perform at least some of the multimedia control functions. The cellular module 221 may include a CP.

Each of the Wi-Fi module 223, the BT module 225, the GPS module 227, and the NFC module 228 may include a processor for processing data transmitted/received through the corresponding module. Although the cellular module 221, the Wi-Fi module 223, the BT module 225, the GPS module 227, and the NFC module 228 are shown as separate components, at least some of the cellular module 221, the Wi-Fi module 223, the BT module 225, the GPS module 227, and the NFC module 228 may be included in one integrated chip (IC) or one IC package. For example, at least some (e.g., the CP corresponding to the cellular module 221 and the Wi-Fi processor corresponding to the Wi-Fi module 222) of the processors corresponding to the cellular module 221, the Wi-Fi module 223, the BT module 225, the GPS module 227, and the NFC module 228 may be implemented by one SoC.

The RF module 229 transmits/receives data, for example, an RF signal. The RF module 229 may include a transceiver, a power amp module (PAM), a frequency filter, a low noise amplifier (LNA) and the like. Further, the RF module 229 may further include a component for transmitting/receiving electronic waves over a free air space in wireless communication, for example, a conductor, a conducting wire, and the like. Although the cellular module 221, the Wi-Fi module 223, the BT module 225, the GPS module 227, and the NFC module 228 share one RF module 229 in FIG. 2, at least one of the cellular module 221, the Wi-Fi module 223, the BT module 225, the GPS module 227, and the NFC module 228 may transmit/receive an RF signal through a separate RF module.

The SIM 224 may be an embedded SIM or may be a card including a SIM which may be inserted into a slot formed in a particular portion of the electronic device 201. The SIM 224 includes unique identification information (e.g., integrated circuit card identifier (ICCID)) or subscriber information (e.g., international mobile subscriber identity (IMSI).

The memory 230 may include an internal memory 232 or an external memory 234. The internal memory 232 may include at least one of a volatile memory (e.g., a random access memory (RAM), a dynamic RAM (DRAM), a static RAM (SRAM), a synchronous dynamic RAM (SDRAM), and the like), and a non-volatile memory (e.g., a read only memory (ROM), a one-time programmable ROM (OTPROM), a programmable ROM (PROM), an erasable and programmable ROM (EPROM), an electrically erasable and programmable ROM (EEPROM), a mask ROM, a flash ROM, a not and (NAND) flash memory, a not or (NOR) flash memory, and the like). The internal memory 232 may be a solid state drive (SSD).

The external memory 234 may include a flash drive, for example, a compact flash (CF), a secure digital (SD), a micro-SD, a mini-SD, an extreme digital (xD), or a memory stick. The external memory 234 may be functionally connected to the electronic device 201 through various interfaces. The electronic device 201 may further include a storage device (or storage medium) such as a hard drive.

The sensor module 240 measures a physical quantity or detects an operation state of the electronic device 201, and converts the measured or detected information to an electronic signal. The sensor module 240 may include at least one of a gesture sensor 240A, a gyro sensor 240B, an atmospheric pressure (barometric) sensor 240C, a magnetic sensor 240D, an acceleration sensor 240E, a grip sensor 240F, a proximity sensor 240G, a red, green, and blue (RGB) sensor 240H, a biometric sensor 240I, a temperature/humidity sensor 240J, an illumination (light) sensor 240K, and a ultraviolet (UV) sensor 240M. Additionally or alternatively, the sensor module 240 may include an E-nose sensor, an electromyography (EMG) sensor, an electroencephalogram (EEG) sensor, an electrocardiogram (ECG) sensor, an infrared (IR) sensor, an iris sensor, a fingerprint sensor, and the like. The sensor module 240 may further include a control circuit for controlling one or more sensors included in the sensor module 240.

The input device 250 includes a touch panel 252, a (digital) pen sensor 254, a key 256, and an ultrasonic input device 258.

The touch panel 252 may recognize a touch input in at least one of a capacitive type, a resistive type, an infrared type, and an acoustic wave type. The touch panel 252 may further include a control circuit. In the capacitive type, the touch panel 252 may recognize proximity as well as a direct touch. The touch panel 252 may further include a tactile layer. In this event, the touch panel 252 provides a tactile reaction to the user.

The (digital) pen sensor 254 may be implemented using a method identical or similar to a method of receiving a touch input of the user, or using a separate recognition sheet.

The key 256 may include a physical button, an optical key, or a key pad.

The ultrasonic input device 258 is a device which may detect an acoustic wave by a microphone 288 of the electronic device 201 through an input means generating an ultrasonic signal to identify data and may perform wireless recognition.

The electronic device 201 receives a user input from an external device (e.g., computer or server) connected to the electronic device 201 by using the communication module 220.

The display module 260 includes a panel 262, a hologram device 264, and a projector 266.

The panel 262 may be an LCD or an active matrix OLED (AM-OLED). The panel 262 may be implemented to be flexible, transparent, or wearable. The panel 262 may be configured with the touch panel 252 as a single module.

The hologram device 264 shows a stereoscopic image in the air by using interference of light.

The projector 266 projects light on a screen to display an image. For example, the screen may be located inside or outside the electronic device 201.

The display 260 may further include a control circuit for controlling the panel 262, the hologram device 264, and the projector 266.

The interface 270 include a HDMI 272, a USB 274, an optical interface 276, and a D-subminiature (D-sub) 278.

The interface 270 may include a mobile high-definition link (MHL) interface, an SD card/multi-media card (MMC), or an infrared data association (IrDA) standard interface.

The audio module 280 bi-directionally converts a sound and an electronic signal. The audio module 280 processes sound information input or output through a speaker 282, a receiver 284, an earphone 286, and the microphone 288.

The camera module 291 is a device which may photograph a still image and a video. The camera module 291 may include one or more image sensors (e.g., a front sensor or a back sensor), an ISP, or a flash (e.g., an LED or xenon lamp).

The power managing module 295 manages power of the electronic device 201. The power managing module 295 may include a power management integrated circuit (PMIC), a charger IC, or a battery gauge.

The PMIC may be mounted to an integrated circuit or an SoC semiconductor. A charging method may be divided into wired and wireless methods. The charger IC charges a battery and prevents over-voltage or over-current from flowing from a charger. The charger IC includes a charger IC for at least one of the wired charging method and the wireless charging method. The wireless charging method may include a magnetic resonance method, a magnetic induction method and an electromagnetic wave method, and additional circuits for wireless charging, for example, circuits such as a coil loop, a resonant circuit, a rectifier and the like may be added.

The battery gauge measures a remaining quantity, a voltage, a current, or a temperature of the battery 296. The battery 296 may store or generate electricity and supply power to the electronic device 201 by using the stored or generated electricity. The battery 296 may include a rechargeable battery or a solar battery.

The indicator 297 shows particular statuses of the electronic device 201 or a part (e.g., processor 210) of the electronic device 201, for example, a booting status, a message status, a charging status and the like.

The motor 298 converts an electrical signal to a mechanical vibration.

The electronic device 201 may include a processing unit (e.g., GPU) for supporting a module TV. The processing unit for supporting the mobile TV may process media data according to a standard of digital multimedia broadcasting (DMB), digital video broadcasting (DVB), mediaFLO™ and the like.

Each of the components of the electronic device 201, according to various embodiments of the present disclosure, may be implemented by one or more components and the name of the corresponding component may vary depending on a type of the electronic device. The electronic device 201 may include at least one of the above described components, a few of the components may be omitted, or additional components may be further included. Also, some of the components of the electronic device 201 may be combined to form a single entity, and thus may equivalently execute functions of the corresponding components before being combined.

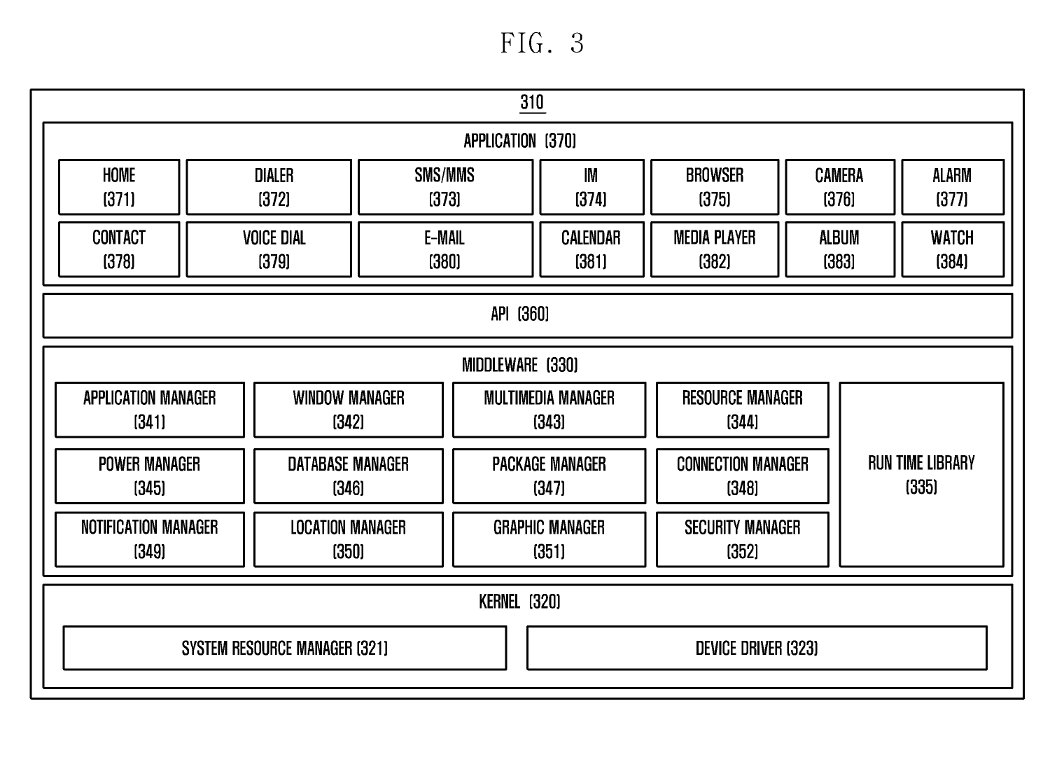

FIG. 3 is a block diagram of a configuration of a program module, according to an embodiment of the present disclosure.

Referring to FIG. 3, a program module 310 is provided. The program module 310 may be included, e.g. stored, in the electronic device 101. At least a part of the program module 310 may be configured by software, firmware, hardware, and/or combinations thereof The program module 310 may include an OS that is implemented in hardware to control resources related to the electronic device 101, and/or at least one application 370, driven on the OS. For example, the OS may be Android™, iOS™, Windows™, Symbian™, Tizen™, Bada™, and the like. The program module 310 may include a kernel 320, middleware 330, an API 360, and at least one application 370. At least part of the program module 310 may be preloaded on the electronic device 101 or downloaded from a server (e.g., a first external electronic device 102, the second external electronic device 104, or the server 106).

The kernel 320 may include a system resource manager 321 and/or a device driver 323.

The system resource manager 321 may include a process manager, a memory manager, and a file system manager. The system resource manager 321 may control, allocate, and/or collect system resources.

The device driver 323 may include a display driver, a camera driver, a BT driver, a shared memory driver, a USB driver, a keypad driver, a Wi-Fi driver, and an audio driver. Further, the device driver 323 may include an inter-process communication (IPC) driver.

The middleware 330 may include a plurality of modules implemented in advance for providing functions commonly used by the application 370. Further, the middleware 330 may provide the functions through the API 360 such that the application 370 may efficiently use restricted system resources within the electronic device 101. For example the middleware 330 may include at least one of a runtime library 335, an application manager 341, a window manager 342, a multimedia manager 343, a resource manager 344, a power manager 345, a database manager 346, a package manager 347, a connection manager 348, a notification manager 349, a location manager 350, a graphic manager 351, and a security manager 352 [symbol] .

The runtime library 335 may include a library module that a compiler uses in order to add a new function through a programming language while the application 370 is being executed. The runtime library 335 may perform an input/output, memory management, and/or an arithmetic function.

The application manager 341 may manage a life cycle of the application 370.

The window manager 342 may manage graphical user interface (GUI) resources used by a screen.

The multimedia manager 343 may detect formats used for reproduction of various media files, and may perform encoding and/or decoding of a media file by using a codec suitable for the corresponding format.

The resource manager 344 may manage resources such as a source code, a memory, and a storage space of the application 370.

The power manager 345 may manage a battery and/or power, while operating together with a basic input/output system (BIOS), and may provide power information used for operation of the electronic device 101.

The database manager 346 may manage generation, search, and/or change of a database to be used by at the application 370.

The package manager 347 may manage installation and/or an update of an application distributed in a form of a package file.

The connection manager 348 may manage wireless connectivity such as Wi-Fi or BT.

The notification manager 349 may display and/or notify a user of the electronic device 101 of an event, such as an arrival of a message, an appointment, a reminder, a proximity notification, and the like, in such a way that does not disturb the user.

The location manager 350 may manage location information of the electronic device 101.

The graphic manager 351 may manage a graphic effect which will be provided to a user of the electronic device 101, and/or a user interface related to the graphic effect.

The security manager 352 may provide all security functions used for system security and/or user authentication.

When the electronic device 101 has a telephone call function, the middleware 330 may further include a telephony manager for managing a voice and/or video communication function of the electronic apparatus.

The middleware 330 may generate and use a new middleware module through various functional combinations of the aforementioned internal modules. The middleware 330 may provide modules specialized according to types of OSs in order to provide differentiated functions. Further, the middleware 330 may dynamically remove some of the existing elements and/or add new elements. Accordingly, the middleware 330 may exclude some of the above-described elements, include other elements, and/or substitute the above-described elements with elements having a different name and performing a similar function.

The API 360 is a set of API programming functions, and may be provided with a different configuration according to the OS. For example, in a case of Android™ or iOS™, one API set may be provided for each of platforms, and in a case of Tizen™, two or more API sets may be provided.

The application 370 may include a preloaded application and/or a third party application. The application 370 may include one or more of the following: a home application 371 a dialer application 372, an SMS/multimedia messaging service (MMS) application 373, an instant messaging (IM) application 374, a browser application 375, a camera application 376, an alarm application 377, a contact application 378, a voice dial application 379, an email application 380, a calendar application 381, a media player application 382, an album application 383, a watch application 384. The application 370 may additionally include a health care application (e.g., for the measurement of blood pressure, exercise intensity, etc.), or an application for providing environment information (e.g., for providing atmospheric pressure, humidity, or temperature information). However, the present embodiment is not limited thereto, and the application 370 may include any other similar and/or suitable application.

The application 370 may include an information exchange application for supporting information exchange between the electronic device 101 and an external device (e.g., the first external electronic device 102 or the second external electronic device 104). The information exchange application may include a notification relay application for relaying specific information to the external devices or a device management application for managing external devices.

The notification relay application includes a function for relaying notification information, created in other applications of the electronic device 101 (e.g., SMS/MMS application, email application, health care application, environment information application, etc.) to external devices (e.g., the external electronic devices 102 and 104). In addition, the notification relay application includes a function for receiving notification information from external devices to provide the received information to a user.

The device management application manages (e.g., installs, removes or updates) at least one function of an external device (e.g., external electronic devices 102 and 104) communicating with the electronic device 101. Examples of the function are a function of turning-on/off the external device or part of the external device, a function of controlling the brightness (or resolution) of the display, applications running on the external device, services provided by the external device, etc. Examples of the services are a call service, a messaging service, etc.

The application 370 may include an application (e.g., a health care application of a mobile medical device) based on specified attributes of an external device (e.g., the external electronic devices 102 and 104). The application 370 may include an application received from an external device (e.g., the server 106 and the external electronic devices 102 and 104).

It should be understood that the components of the program module 310 may be called different names according to types of OSs.

According to various embodiments, at least part of the program module 310 can be implemented with software, firmware, hardware, or any combination thereof. At least part of the program module 310 can be implemented (e.g., executed) by a processor (e.g., the processor 210). At least part of the programing module 310 may include modules, programs, routines, sets of instructions or processes, etc., in order to perform one or more functions.

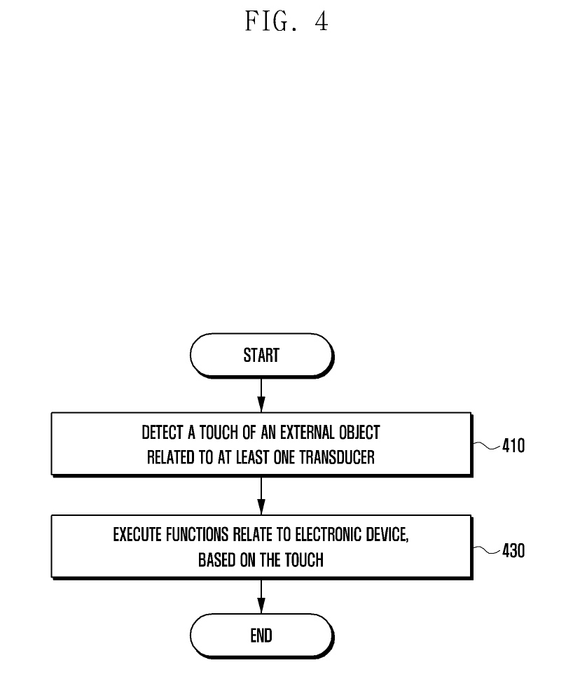

FIG. 4 is a flowchart of a method of controlling an electronic device using a transducer of an electronic device, according to an embodiment of the present disclosure.

Referring to FIG. 4, a method of using a transducer included in the electronic device 201 to control the electronic device 201 is described.

At step 410, the electronic device 201, configured to include at least one component (i.e., transducer), detects a touch of an external object, related to at least one transducer.

That is, at least one transducer is installed inside the electronic device 201 and is disposed adjacent to at least one opening of the electronic device 201. At least one transducer is configured to include an audio output transducer and/or an audio input transducer. For example, the audio output transducer may include the speaker 282, the receiver 284, and the earphones 286. The audio input transducer may include the microphone 288.

In order to detect a touch of an external object, related to at least one transducer, the electronic device 201 is includes an impedance detection circuit and/or a noise detection circuit. For example, the impedance detection circuit may be configured to detect impedance created when the transducer outputs an audio signal. The noise detection circuit may be configured to detect touch noise created when the transducer receives an audio signal.

At step 430, the electronic device 201 executes a related function of the electronic device 201 based on the detected touch.

That is, when the electronic device 201 detects the touch of the external object, related to at least one transducer, the electronic device 201 recognizes the touch of the external object as an input signal, and executes a related function. For example, the electronic device 201 may execute a function of its hardware (e.g., a camera 291, a transducer, etc.), software (e.g., an application 370), or firmware, or a combination thereof

For example, when the electronic device 201 operates in a camera shoot mode, the electronic device 201 may control the camera 291 to perform a shoot function, based on a touch of an external object. The electronic device 201 may be set in such a way that when the electronic device 201 detects a touch of the external object, related to at least one transducer, during an idle mode, the electronic device 201 enters a camera shoot mode.

As another example, the electronic device 201 may control the input/output of audio signals of at least one transducer, based on a touch of an external object. For example, when a ringtone, alarm clock sound or music is output via the speaker 282 of the electronic device 201, the electronic device 201 is controls the audio signals output from the speaker 282 based on a touch of the external object. That is, when the user of the electronic device 201 touches an opening adjacent to a transducer outputting the audio signals, the electronic device 201 controls the transducer to mute or block the audio signals, such as a ringtone, an alarm clock sound or music, based on the touch. In addition, when the user of the electronic device 201 touches an opening adjacent to a transducer receiving the audio signals, the electronic device 201 controls the transducer to stop receiving the audio signal.

As another example, the electronic device 201 may control functions of a specified application or specified firmware (e.g., controlling audio volume of a music application, etc.), etc., based on a touch of an external object. For example, if the electronic device 201 detects a touch of an external object, related to at least one transducer, in a lock screen state, the electronic device 201 is capable of unlocking the lock screen or locking the screen of the electronic device 201.

The electronic device 201 obtains the number of touches detected at at least one opening during a preset period of time, and executes a preset function based on the obtained number of touches. For example, if a user repeatedly touches an opening disposed adjacent to a transducer of the electronic device 201 for a preset period of time and then removes the touch therefrom, the electronic device 201 detects touch noise that arises during the period of time. Therefore, the electronic device 201 is able to obtain the number of detections of touch noise, and execute a preset function based on the obtained number of detections of touch noise. For example, the electronic device 201 may be preset in such a way that if touch noise is detected twice during a preset period of time, the electronic device 201 enables the front and rear cameras to enter an activated mode. The electronic device 201 may also be preset in such a way that if touch noise is detected three times during a preset period of time, the electronic device 201 enables the front and rear cameras to enter a beauty shot mode.

The electronic device 201 may be configured in such a way as to recognize a touch pattern for at least one opening and execute a preset function. For example, the electronic device 201 is capable of recognizing a touch pattern for an opening disposed adjacent to the transducer, e.g., a pattern of occurrence of touch noise, a change in sensitivity of touch noise, etc. The electronic device 201 is capable of comparing the recognized pattern with a preset pattern. If the electronic device 201 ascertains that the recognized pattern is identical to a preset pattern, the electronic device 201 executes a preset function, for unlocking the lock screen of the electronic device 201.

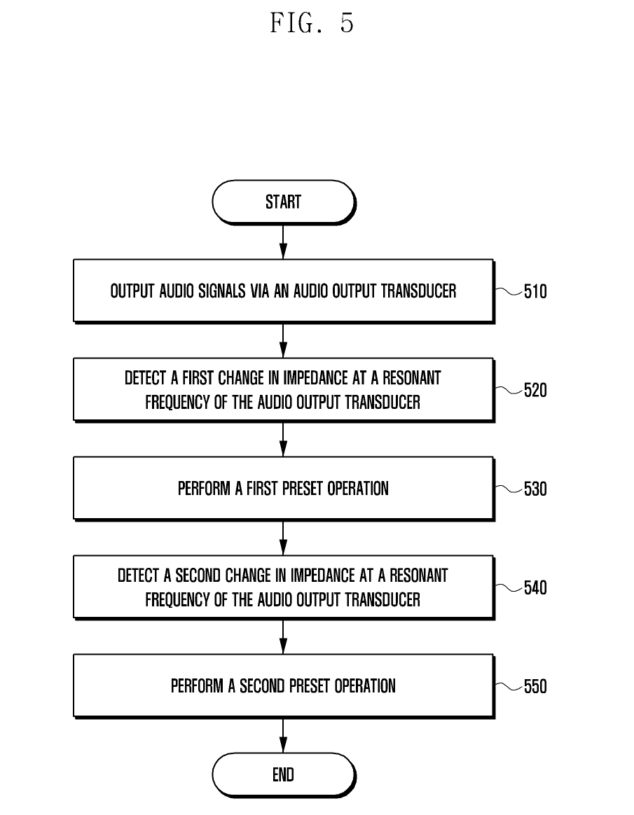

A method of controlling the electronic device 201 using various types of transducers, e.g., an audio output transducer and an audio input transducer, is explained in detail with reference to FIGS. 5 to 12.

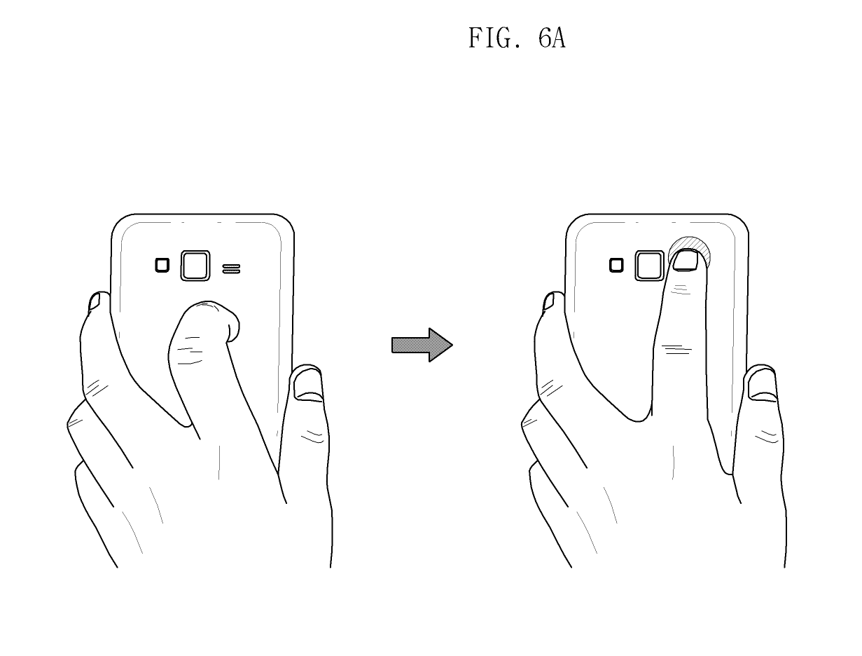

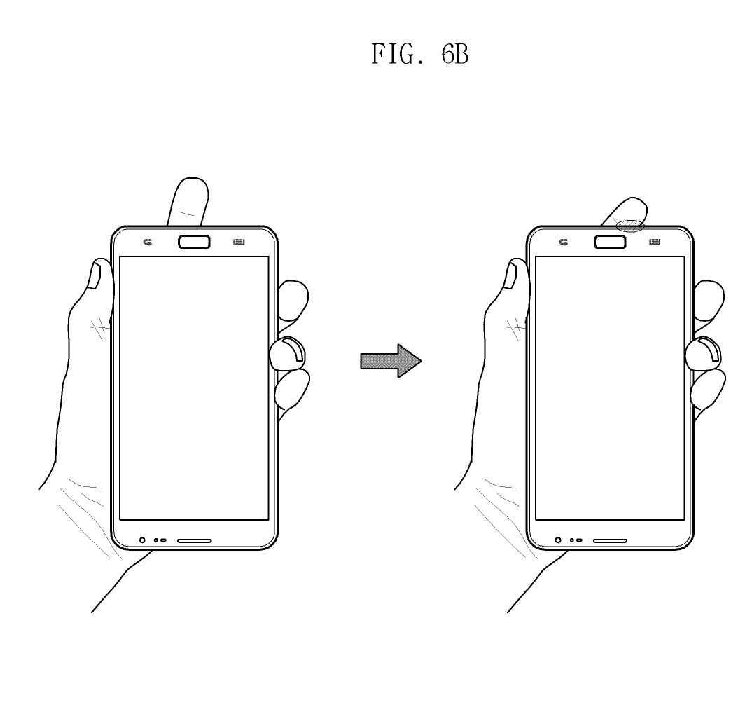

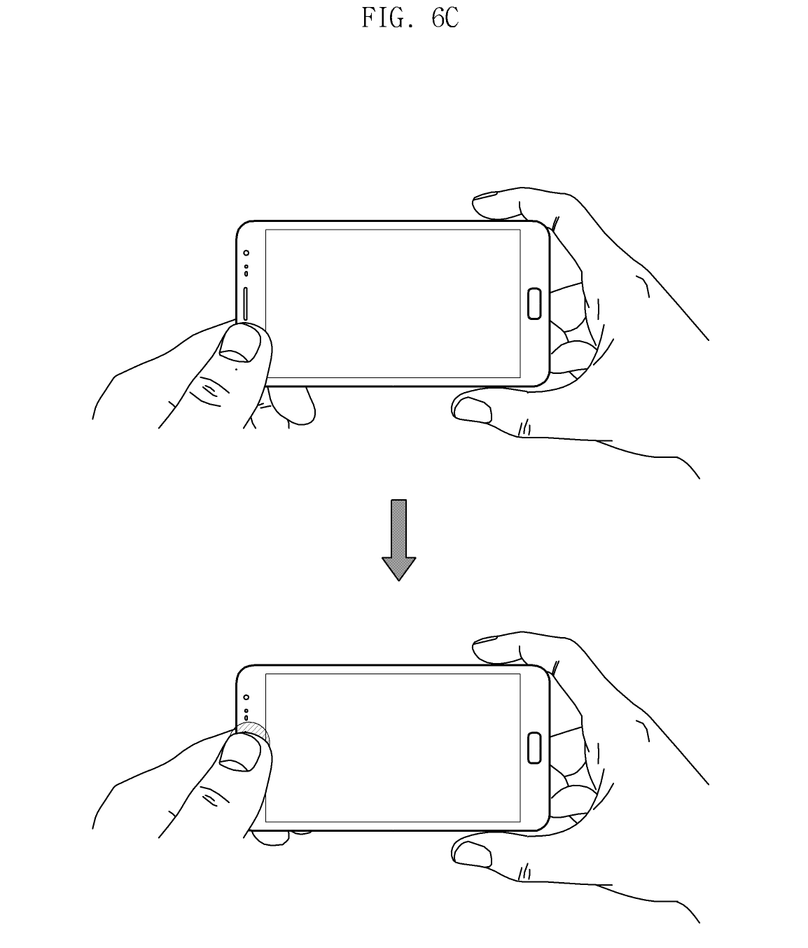

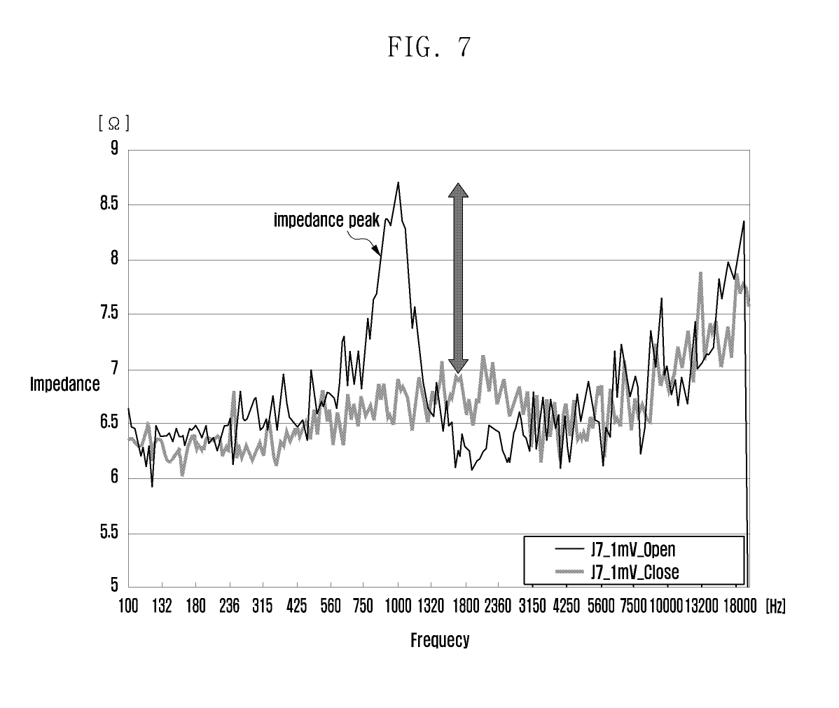

FIG. 5 is a flowchart of a method of controlling an electronic device using an audio output transducer of an electronic device, according to an embodiment of the present disclosure. FIGS. 6A to 6C illustrate a method of touching an opening disposed adjacent to an audio output transducer of an electronic device, according to an embodiment of the present disclosure. FIG. 7 is a graph illustrating a change of impedance when a touch is applied to an opening disposed adjacent to an audio output transducer of an electronic device, according to an embodiment of the present disclosure.

Referring to FIG. 5, a method of using an audio output transducer included in the electronic device 201 to control the electronic device 201 is described.

At step 510, the electronic device 201 receives audio output signals, and outputs the audio output signals via an audio output transducer in operation 510.

The audio output signals may be created by users, external electronic devices, external servers, base stations, etc. If the electronic device 201 receives an audio output signal, the electronic device 201 may output various types of preset audio signals, e.g., a notification sound, music, white noise, etc. An example of the audio signal output from the electronic device 201 may also be a relatively low level of sound to such an extent that the sound can be detected, e.g., a sound created when an external object physically opens/closes an opening. If the processor applies a signal of a relatively small level, e.g., 1 mV (0.001 V), to the audio output transducer, the audio output transducer may output an audio signal that has a level to such an extent that users can just hear the audio in a quiet environment.

The audio output transducer is installed inside the housing of the electronic device 201 and is disposed adjacent to at least one opening formed in one side of the housing. For example, the audio output transducer may include the speaker 282 and/or the receiver 284.

At step 520, the electronic device 201 detects a first change in impedance at a resonant frequency of the audio output transducer.

Resonance is a phenomenon where external force drives a structure at the same natural frequency of the structure and thus the structure oscillates with greater amplitude. For example, if current is applied to the diaphragm of the speaker 282 attached to a coil at the same natural frequency of the diaphragm, the diaphragm vibrates with the highest displacement. In this case, the electronic device 201 is capable of detecting a touch of an external object, using the vibration of the diaphragm with the highest displacement.

The first impedance change on a resonant frequency of the audio output transducer may be created by a touch physically applied to an opening formed adjacent to the audio output transducer. For example, if a user touches, with an external object (e.g., the finger or a tool), at least one opening which is formed in one side of the housing of the electronic device 201, the electronic device 201 creates a first impedance change on a resonant frequency of the audio output transducer disposed adjacent to the touched opening. If the touch is removed from at least one transducer where the touch occurred, the electronic device 201 may generate a first impedance change on a resonant frequency of an audio output transducer disposed adjacent to the opening from which the touch is removed.

Referring to FIGS. 6A to 6C, a user of the electronic device 201 can touch with a finger, for example, at least one opening formed in one side of the housing of the electronic device 201. For example, as shown in FIGS. 6A and 6B, the user can touch an opening which is formed in the back side or lateral side of the housing of the electronic device 201 and is disposed adjacent to the speaker 282 inside the housing. Alternatively, as shown in FIG. 6C, the user can also touch an opening, which is formed in the front side of the housing of the electronic device 201 and is disposed adjacent to the receiver 284 inside the housing.

Referring to FIG. 7, when a touch is applied to an opening disposed adjacent to an audio output transducer, the impedance change occurs at or near a resonant frequency. For example, if an audio output transducer forms a resonant frequency in a specified range of frequency band, an impedance peak is induced in the specified range of frequency band. The impedance peak in the specified range of frequency band can experience a large amount of change when a touch is applied to an opening adjacent to the audio output transducer.

When a touch is not applied to an opening formed adjacent to the audio output transducer, the impedance peak is formed between 750˜1000 Hz in which a resonant frequency is formed. In this case, when the user touches at least one opening formed in one side of the housing of the electronic device 201 the impedance peak disappears between 750˜1000 Hz in which a resonant frequency is formed. Based on this feature, the electronic device 201 is able to determine whether a physical touch is applied to an opening formed adjacent to the audio output transducer.

The electronic device 201 may further include an impedance detection circuit for detecting a change in impedance. The impedance detection circuit may be designed in such a way as to detect impedance of an audio output transducer inside the electronic device 201, i.e., an impedance change at a resonant frequency of the audio output transducer.

At step 530, the electronic device 201 performs a first preset operation after detecting the first change in impedance at the resonant frequency of the audio output transducer.

The first preset operation may be various operations (functions) that the electronic device 201 can perform based on its received input signals. Examples of the first preset operation are an operation for controlling camera-related functions (e.g., a function for entering a camera shoot mode, a function for entering a camera shoot set-up mode), an operation for unlocking the lock screen of the electronic device 201, a function for muting or blocking a ringtone when an incoming call is received, a function for controlling an audio output transducer outputting audio signals.

The electronic device 201 may have stored a degree of change in impedance according to a physical touch applied to an opening. For example, the electronic device 201, which has stored a degree of change in impedance which can occur when a physical touch is applied to an opening, may be configured in such a way that a first preset operation is not performed by an impedance change which is generated by causes other than a physical touch. Therefore, the electronic device 201 is capable of determining whether a change in impedance that occurred in the audio output transducer is caused by a physical touch applied to the opening. If the electronic device 201 ascertains that a change in impedance is caused by a physical touch, the electronic device 201 performs the first preset operation.

At step 540, the electronic device 201 detects a second change in impedance at a resonant frequency of the audio output transducer.

The second impedance change at a resonant frequency of the audio output transducer may be caused by the first impedance change. For example, if the first impedance change at a resonant frequency of an audio output transducer is caused when a touch is applied to at least one opening formed in one side of the housing of the electronic device 201, the second impedance change may occur when the touch is removed from the touched opening or openings. Alternatively, if the first impedance change at a resonant frequency of an audio output transducer is caused when a touch is removed from at least one opening formed in one side of the housing of the electronic device 201, the second impedance change may occur when a touch is re-applied to the opening or openings.

At step 550, the electronic device 201 performs a second preset operation after detecting the second impedance change at the resonant frequency of the audio output transducer.

The second preset operation may be various operations (functions) that the electronic device 201 can perform, according to the reception of input signals, based on the first operation that the electronic device 201 has performed. For example, if the first operation is an operation for controlling camera-related functions, the second preset operation may be at least one of an operation for controlling the change between modes of a shoot mode (e.g., a mode for switching between the front and rear cameras when the camera 291 captures images, a manual shoot mode, a beauty shot mode, a panorama shot mode, etc.), an operation for controlling the camera shoot settings (e.g., ISO and shutter speed settings, etc.), etc. If the first operation is an operation for unlocking the lock screen of the electronic device 201, the second preset operation may be an operation for changing the unlock screen to the lock screen. If the first operation is an operation for muting or blocking a ringtone or controlling the audio output transducer outputting an audio signal, the second-preset operation may be an operation for re-outputting the ringtone or returning the audio output transducer to the previous state before the audio output transducer was controlled.

The electronic device 201 may have stored a degree of change in impedance according to a physical touch applied to an opening. For example, the electronic device 201, which has stored a degree of change in impedance which can occur when a physical touch is applied to an opening, may be configured in such a way that a second preset operation is not performed by an impedance change which is generated by causes other than a physical touch. Therefore, the electronic device 201 is capable of determining whether a change in impedance that occurred in the audio output transducer is caused by a physical touch applied to the opening. If the electronic device 201 ascertains that a change in impedance is caused by a physical touch, the electronic device 201 performs the second preset operation.

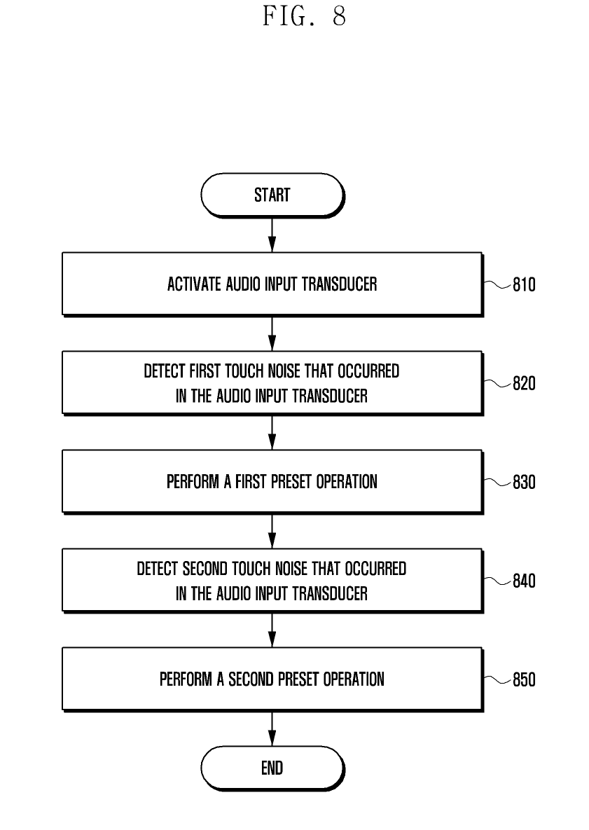

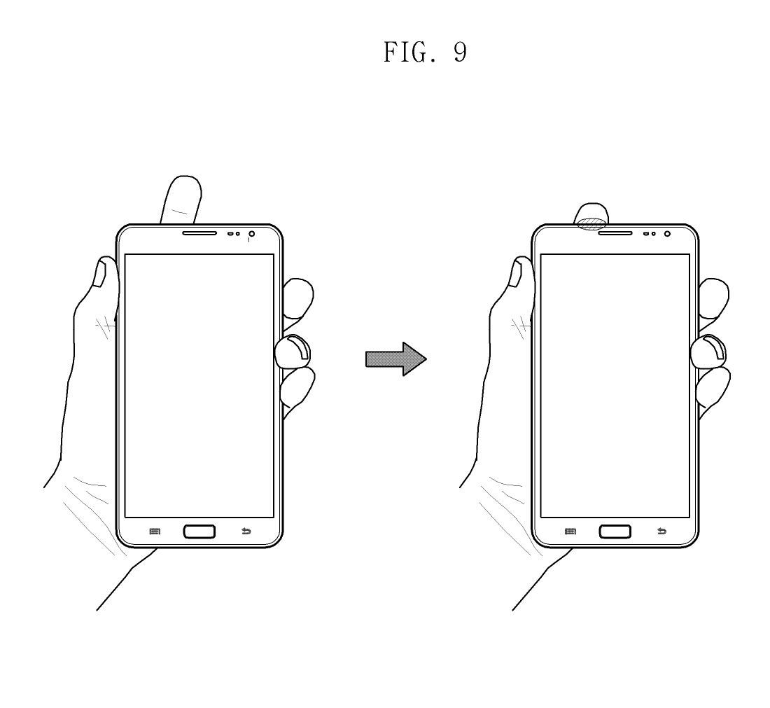

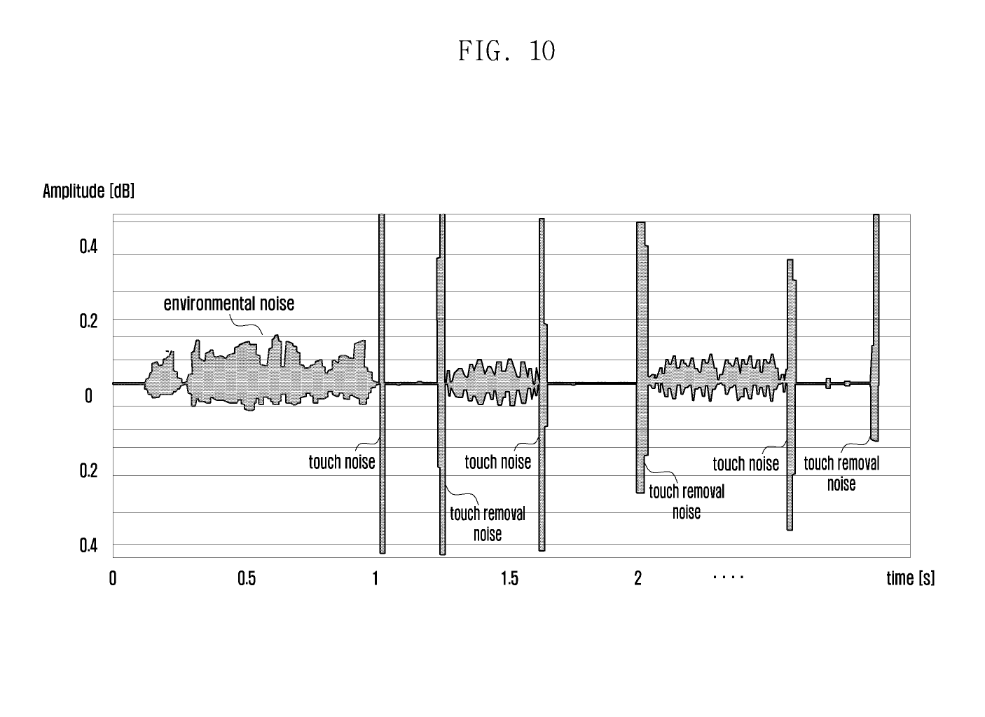

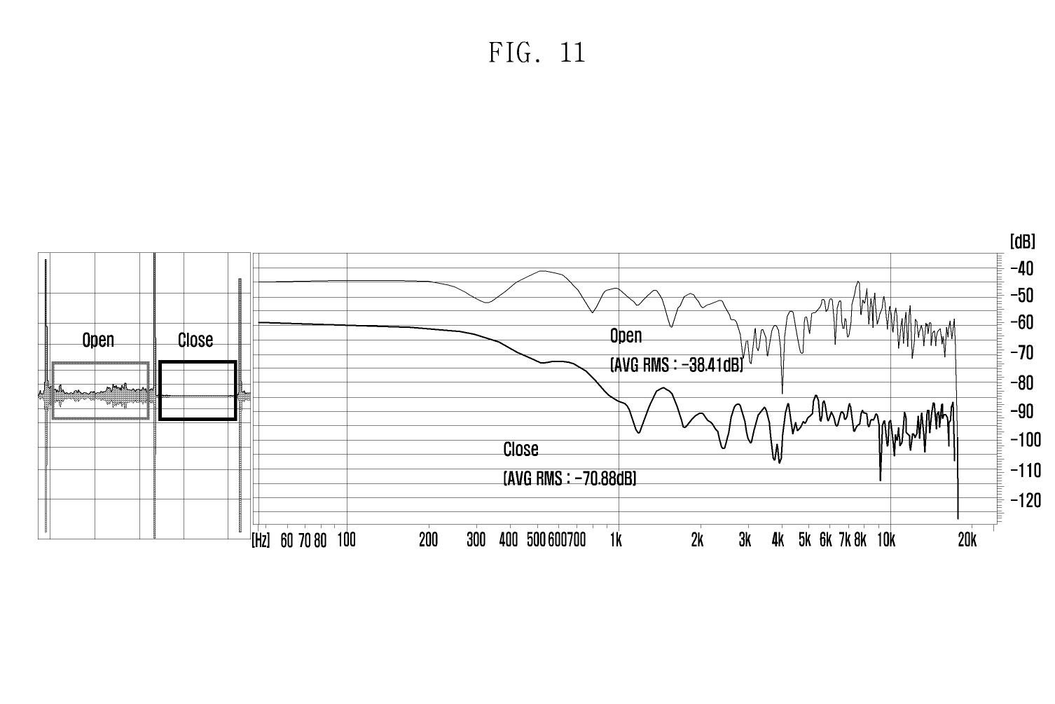

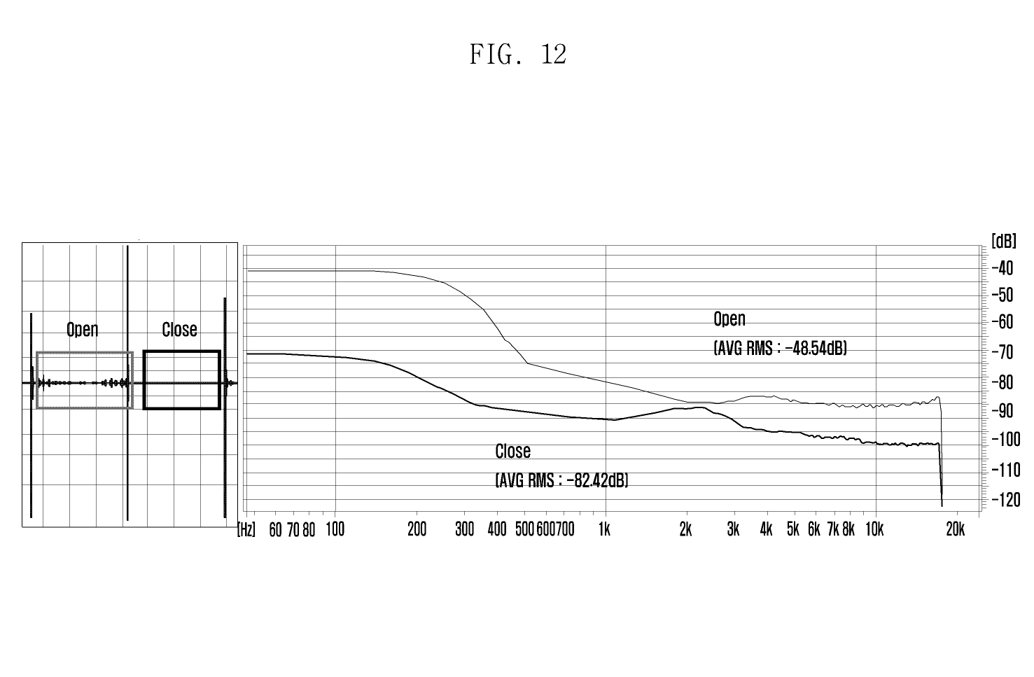

FIG. 8 is a flowchart of a method of controlling an electronic device using an audio input transducer of an electronic device, according to an embodiment of the present disclosure. FIG. 9 illustrates a method of touching an opening disposed adjacent to an audio input transducer of an electronic device, according to an embodiment of the present disclosure. FIG. 10 is a graph illustrating a change in an audio input signal created when a touch is applied to or removed from an opening disposed adjacent to an audio input transducer of an electronic device, according to an embodiment of the present disclosure. FIGS. 11 and 12 are graphs illustrating a change in an audio input signal created when a touch is applied to or removed from an opening disposed adjacent to an audio input transducer of an electronic device in various environments, according to an embodiment of the present disclosure.

Referring to FIG. 8, a method of using an audio input transducer included in the electronic device 201 to control the electronic device 201 is described.

At step 810, the electronic device 201 receives a signal for activating an audio input transducer, and activates the audio input transducer.

The signal for activating an audio input transducer may be created by users, external electronic devices, external servers, base stations, etc. The audio input transducer is installed inside the housing of the electronic device 201 and is disposed adjacent to at least one opening formed in one side of the housing. For example, the audio input transducer may include the microphone 288.

The electronic device 201 may also be controlled by at least one of a microphone of earphones connected to the electronic device 201, a microphone included in an external electronic device (e.g., a microphone of a BT headset, a microphone of a BT speaker, etc.), etc., as well as the audio input transducer of the electronic device 201.

At step 820, the electronic device 201 detects a first touch noise that occurs in the audio input transducer.

Touch noise is refers to noise, e.g., vibration, generated when the user opens or closes, with a finger, for example, an opening formed adjacent to the audio input transducer. Touch noise may mix with signals. The electronic device 201 detects the first touch noise that occurs when a physical touch is applied to an opening formed adjacent to the audio input transducer. For example, if the user of the electronic device 201 touches, with a finger and/or a tool, at least one opening formed in one side of the housing of the electronic device 201, the first touch noise may arise at the audio input transducer disposed adjacent to the touched opening.

The electronic device 201 may further include a noise detection circuit for detecting the first touch noise that occurs at the audio input transducer.

Referring to FIG. 9, a user of the electronic device 201 can touch, with a finger, for example, at least one opening formed in one side of the housing of the electronic device 201. For example, the user can touch an opening which is formed in one side of the housing of the electronic device 201 and is disposed adjacent to the microphone 288 inside the housing.

Referring to FIG. 10, an audio input transducer may receive external environment noise as an audio signal, in a state where a touch is not applied to an opening disposed adjacent to the audio input transducer. When a user of the electronic device 201 touches the opening, touch noise may arise in the audio input transducer. In addition, when the user of the electronic device 201 removes the touch from the opening, touch noise may also arise in the audio input transducer because the removal of the touch from the opening causes a vibration, which causes noise and, as a result, the vibration noise is introduced as a touch noise.

At step 830, the electronic device 201 performs a first preset operation after detecting the first touch noise in the audio input transducer.

The first preset operation may be various operations (functions) that the electronic device 201 can perform based on received input signals. Examples of the first preset operation are an operation for controlling camera-related functions (e.g., a function for entering a camera shoot mode, a function for entering a camera shoot set-up mode), an operation for unlocking the lock screen of an electronic device 201, a function for muting or blocking a ringtone when an incoming call is received, a function for controlling an audio output transducer outputting audio signals.

The electronic device 201 may have stored a degree of change in inflow of external environment noise or touch noise according to a physical touch applied to an opening. For example, the electronic device 201, which has stored a degree of change in inflow of external environment noise or touch noise, which can occur when a physical touch is applied to an opening, may be configured in such a way that a first preset operation is not performed by a change in inflow of external environment noise or touch noise which is generated by causes other than a physical touch. Therefore, the electronic device 201 is capable of determining whether a change in inflow of external environment noise or touch noise that occurred in the audio input transducer is caused by a physical touch applied to the opening. If the electronic device 201 ascertains that a change in inflow of external environment noise or touch noise is caused by a physical touch, the electronic device 201 performs the first preset operation.

At step 840, the electronic device 201 detects a second touch noise that occurs in the audio input transducer.

The second touch noise that occurs in the audio input transducer may be caused by the first touch noise. For example, if the first touch noise that occurred in the audio input transducer is caused when a touch is applied to at least one opening formed in one side of the housing of the electronic device 201, the second touch noise may occur when the touch is removed from the touched opening or openings. If the first touch noise that occurred in an audio input transducer is caused when a touch is removed from at least one opening formed in one side of the housing of the electronic device 201, the second touch noise may occur when a touch is re-applied to the opening or openings.

The electronic device 201 may be implemented in such a way as to execute a preset operation by detecting a change in flow of external environment noise, caused according to the opening/closing operation of an opening disposed adjacent to the audio input transducer, instead of detecting the first touch noise and the second touch noise. For example, since an opening disposed adjacent to the audio input transducer is generally exposed to an external environment and receives external environment noise, if the opening is touched by a user, it may block a certain amount of external environment noise by the user's touch. Referring back to FIG. 10, if touch noise arises while external environment noise flows into the opening, the external environment noise is blocked; however, if touch noise ends, external environment noise starts to flow into the opening. That is, the electronic device 201 is able to use an audio input transducer as an input unit for controlling the electronic device 201, without a noise detection circuit.

Referring to FIG. 11, sample measurement results are shown of a change in a level of an audio input signal when a touch is applied to an opening disposed adjacent to an audio input transducer if there is external environment noise. If a touch is not applied to an opening disposed adjacent to an audio input transducer, a level of an audio input signal according to external environment noise is measured to be an average of −38.41 dB. If a touch is applied to the opening disposed adjacent to the audio input transducer, a level of an audio input signal is measured to be an average of −70.88 dB. That is, the difference between the level of an audio input signal when a touch is not applied to the opening and the level of an audio input signal when a touch is applied to the opening, is 32.47 dB. The electronic device 201 is capable of detecting whether a physical touch is applied to the opening, using the difference of levels of audio input signals.

Referring to FIG. 12, sample measurement results are shown of a change in a level of an audio input signal when a touch is applied to an opening disposed adjacent to an audio input transducer if there is little external environment noise. If a touch is not applied to an opening disposed adjacent to an audio input transducer, a level of an audio input signal according to external environment noise is measured to be an average of −48.54 dB. If a touch is applied to the opening disposed adjacent to the audio input transducer, a level of an audio input signal is measured to be an average of −82.42 dB. That is, the difference between the level of an audio input signal when a touch is not applied to the opening and the level of an audio input signal when a touch is applied to the opening, is 33.88 dB. The electronic device 201 is capable of detecting whether a physical touch is applied to the opening in a state where there is little external environment noise, using the difference of levels of audio input signals.

At step 850, the electronic device 201 performs a second preset operation after detecting the second touch noise of the audio input transducer.

The second preset operation may be various operations (functions) that the electronic device 201 can perform, according to the reception of input signals, based on the first operation that the electronic device 201 has performed. For example, if the first operation is an operation for controlling camera-related functions, the second preset operation may be at least one of an operation for controlling the change between modes of a shoot mode (e.g., a mode for switching between the front and rear cameras when the camera 291 captures images, a manual shoot mode, a beauty shot mode, a panorama shot mode, etc.), an operation for controlling the camera shoot settings (e.g., ISO and shutter speed settings, etc.), etc. If the first operation is an operation for unlocking the lock screen of the electronic device 201, the second preset operation may be an operation for changing the unlock screen to the lock screen. If the first operation is an operation for muting or blocking a ringtone or controlling the audio output transducer outputting an audio signal, the second-preset operation may be an operation for re-outputting the ringtone or returning the audio output transducer the previous state before the audio output transducer was controlled.

The electronic device 201 may have stored a degree of change in inflow of external environment noise or touch noise according to a physical touch applied to an opening. For example, the electronic device 201, which has stored a degree of change in inflow of external environment noise or touch noise which can occur when a physical touch is applied to an opening, may be configured in such a way that a second preset operation is not performed by a change in inflow of external environment noise or touch noise which is generated by causes other than a physical touch. Therefore, the electronic device 201 is capable of determining whether a change in inflow of external environment noise or touch noise that occurs in the audio input transducer is caused by a physical touch applied to the opening. If the electronic device 201 ascertains that a change in inflow of external environment noise or touch noise is caused by a physical touch, the electronic device 201 performs the second preset operation.

In various embodiments of the present disclosure, the electronic device 201 may be configured to detect a touch which is applied to or removed from an opening disposed adjacent to the audio input transducer and to perform a first or second preset operation, based on the detection result.

In various embodiments of the present disclosure, the electronic device 201 may be configured to include at least one transducer and the processor 210. The processor detects a touch of an external object which is related to at least one transducer, and executes a function related to the electronic device, based on the touch.

At least one transducer of the electronic device 201 is includes the speaker 282 or the microphone 288.

If at least one transducer of the electronic device 201 includes the speaker 282, the processor 201 detects a touch of an external object, related to at least one transducer, based on a change in impedance at a natural resonant frequency of the speaker 282.

If at least one transducer of the electronic device 201 includes the microphone 288, the processor 201 detects a touch of an external object, related to at least one transducer, based on the detection of a change in inflow of touch noise and/or external environment noise into the microphone 288.

The electronic device 201 is configured to further include the camera 291. In this case, the processor 210 controls the camera 291 to perform a shoot function, based on the touch, when the electronic device 201 operates in a camera shoot mode or enter a camera shoot mode, based on the touch, when the electronic device 201 operates in an idle mode.

The processor 210 of the electronic device 201 controls at least one transducer to input or output an audio signal, based on the touch.

The processor 210 of the electronic device 201 is set to perform a function of a specified application or specified firmware, based on the touch.

The external object of the electronic device 201 includes at least one of a user's body part, another electronic device, and a tool.

The processor 210 executes a function, related to the electronic device 201, based on a number of touches detected during a preset period of time.

The processor 210 executes a function, related to the electronic device 201, based on a preset touch pattern.

The electronic device 201 is may include at least two transducers. For example, if the electronic device 201 is configured to include two microphones, the electronic device 201 may be set to perform three types of functions corresponding to three types of touch actions, i.e., touching the opening disposed adjacent to the first microphone, touching the opening disposed adjacent to the second microphone, and simultaneously the openings disposed adjacent to both the first and second microphones. It should also be understood that the more audio input/output transducers included in the electronic device 201, the more functions that can be set to be performed.

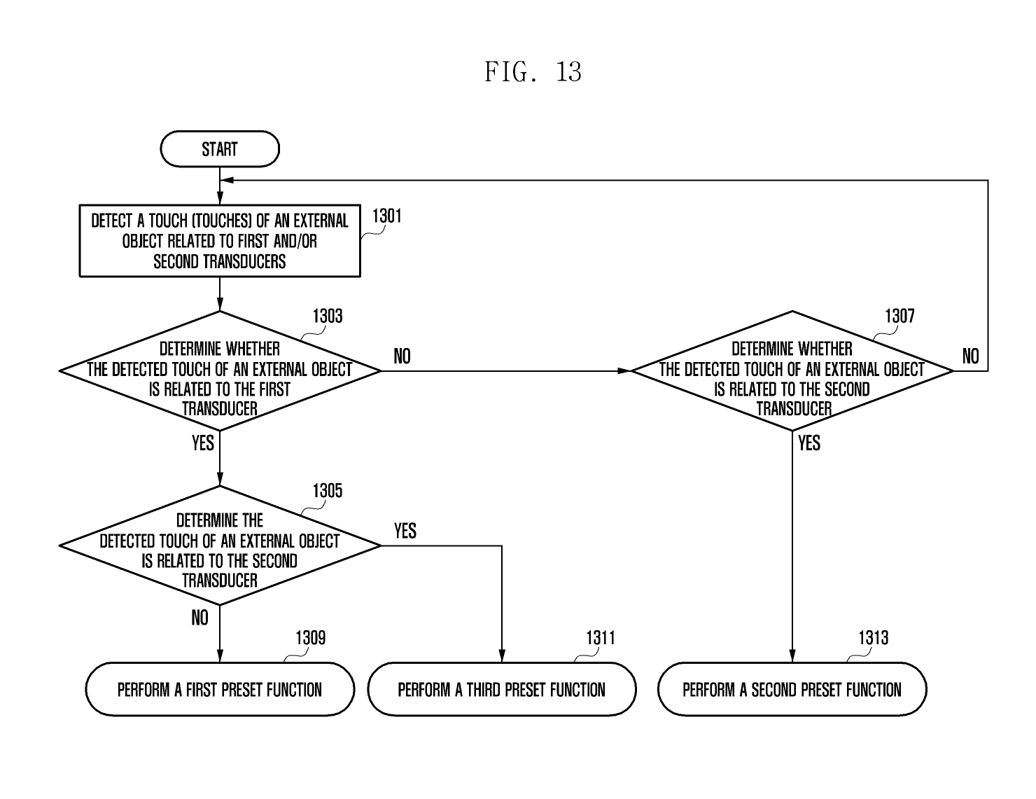

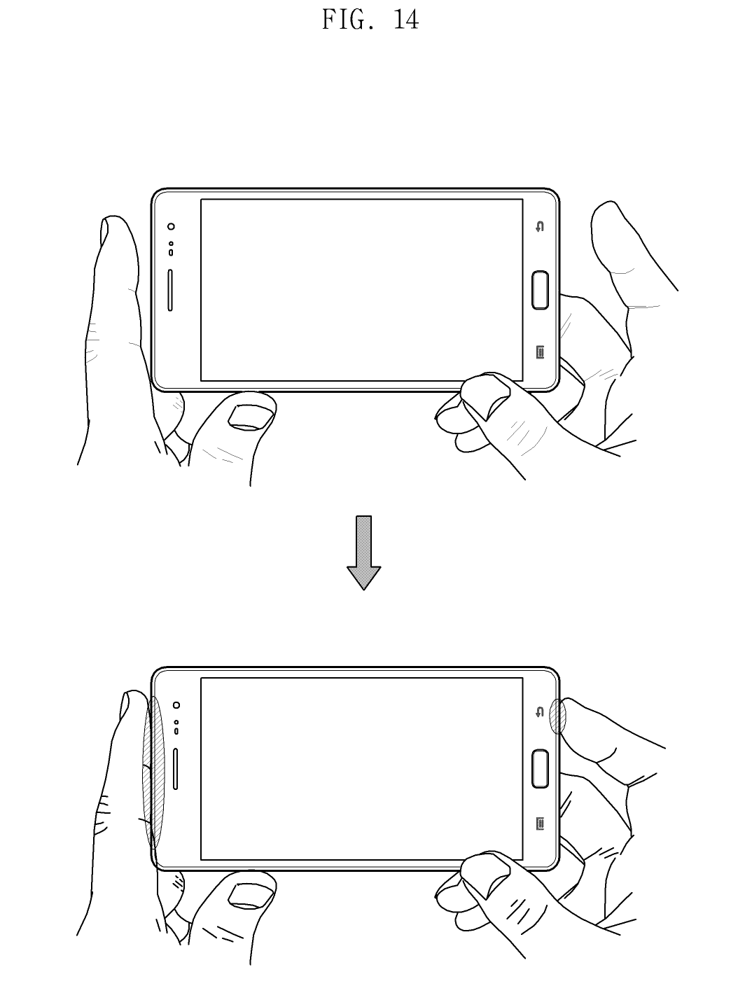

FIG. 13 is a flowchart of a method of controlling an electronic device including at least two transducers, according to an embodiment of the present disclosure. FIG. 14 illustrates a method of simultaneously touching first and second transducers of an electronic device, according to an embodiment of the present disclosure.

Referring to FIG. 13, a method of using a first and second transducer included in the electronic device 201 to control the electronic device 201 is described.

At step 1301, the electronic device 201 detects one or more touches of an external object related to the first and/or second transducers.

For example, at least two transducers are placed inside the housing of the electronic device 201 and are, respectively, disposed adjacent to at least two openings. For example, at least two transducers include and audio output transducer and/or an audio input transducer.

The electronic device 201 may include an impedance detection circuit and/or a noise detection circuit in order to detect a touch of an external object, related to one of the at least two transducers. For example, the impedance detection circuit may be configured to detect impedance created when at least one of the transducers outputs an audio signal, and the noise detection circuit may be configured to detect touch noise that occurs when at least one of the transducers receives an audio signal.

At step 1303, the electronic device 201 is capable of determining whether the detected touch of an external object is related to the first transducer.

The first transducer may be implemented with an audio output transducer and/or an audio input transducer. For example, the electronic device 201 may detect a change in impedance via the audio output transducer, and determine a touch related to the first transducer. The electronic device 201 may also detect noise via the audio input transducer, and determine a touch related to the first transducer.

If the electronic device 201 ascertains that the detected touch of an external object is related to the first transducer then, at step 1305, the electronic device 201 determines if the detected touch of the external object is also related to the second transducer. That is, the electronic device 201 determines whether both the touch is detected on both first transducer and the second transducer.

If the electronic device 201 ascertains that the detected touch of the external object is not related to the second transducer (i.e., the detected touch is only related to the first transducer) then, at step 1309, the electronic device 201 performs a first preset function. The first preset function may be a function for increasing/decreasing an output audio volume or a function for increasing/decreasing the sensitivity to an input audio signal. The first preset function may be a camera-related function (e.g., a function for entering a camera shoot mode, a function for entering a camera shoot set-up mode), a function for unlocking the lock screen of an electronic device 201, a function for muting or blocking a ringtone when an incoming call is received, etc.

On the other hand, if the electronic device 201 ascertains that the detected touch of the external object is related to a second transducer (i.e., the detected touch is related to both the first transducer and the second transducer) then, at step 1311, the electronic device 201 performs a third preset function. The third preset function may be a function for muting/blocking an output audio signal or a function for blocking an input audio signal. That is, the third preset function may be a function for stopping the control of the electronic device 201 using the transducer.

Referring to FIG. 14, a user of an electronic device 201 touches, with fingers, for example, two openings in which transducers that differ from each other are disposed and which are formed in different sides of the housing of the electronic device 201. Alternatively, the user may perform the touch with a tool

If, at step 1303, the electronic device 201 ascertains that the detected touch of the external object is not related to the first transducer then, at step 1307, the electronic device 201 determines whether the detected touch of the external object is related to the second transducer.

If the electronic device 201 ascertains that the detected touch of the external object is not related to the second transducer, the electronic device 201 returns to step 1301.

On the other hand, if the electronic device 201 ascertains that the detected touch of the external object is related to the second transducer (i.e., the detected touch is only related to the second transducer) then, the electronic device 201 performs a second preset function. The second preset function may be a function for decreasing/increasing an output audio volume or a function for decreasing/increasing the sensitivity to an input audio signal. If the first preset function is a function for unlocking the lock screen of an electronic device 201, the second preset function may be a function for changing the unlock screen to the lock screen. If the first preset function is a function for muting or blocking a ringtone, the second preset function may be a function for re-outputting the ringtone, etc.

In various embodiments of the present disclosure, the electronic device 201 may be configured to include a first transducer, a second transducer, and the processor 210. The processor 210 detects a touch of an external object which is related to the first or second transducer, performs a first preset function if the touch is related to the first transducer, and performs a second preset function if the touch is related to the second transducer.

If the touch is related to the first and second transducers, the processor 210 performs a third preset function.

Each of the first and second transducers of the electronic device 201 includes the speaker 282 and/or the microphone 288.

Each of the first, second and third preset functions of the electronic device 201 includes functions related to hardware, software, firmware and a combination thereof

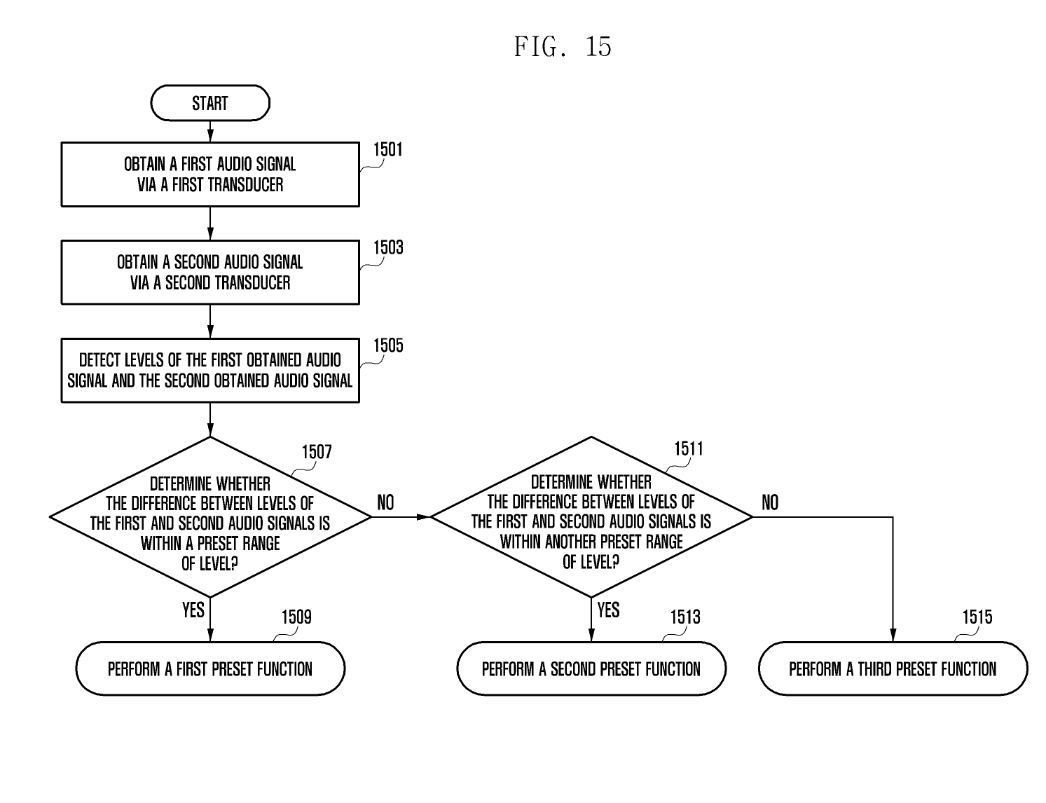

FIG. 15 is a flowchart of a method of controlling an electronic device using a level difference between at least two transducers of an electronic device, according to an embodiment of the present disclosure.

Referring to FIG. 15, a method of using a difference in the levels of audio signals in at least two transducers of the electronic device 201 to control the electronic device 201 is described.

At step 1501, the electronic device 201 obtains a first audio signal via a first transducer. The first transducer may include an audio input transducer. For example, if the electronic device 201 detects a touch of an external object applied to the first transducer, the electronic device 201 obtains a first audio signal according to the occurrence of touch noise.

At step 1503, the electronic device 201 is obtains a second audio signal via a second transducer. The second transducer may include an audio input transducer which differs from that included in the first transducer. For example, if the electronic device 201 detects a touch of an external object applied to the second transducer, the electronic device 201 obtains a second audio signal according to the occurrence of touch noise. At step 1505, the electronic device 201 detects the levels of the first obtained audio signal and the second obtained audio signal. For example, a level of an audio signal may refer to a level difference between a level of an audio signal created according to a touch of an external object related to a transducer and a level of an audio signal created by only the inflow of external environment noise. Additionally, the electronic device 201 is capable of distinguishing between degrees of a touch of an external object related to a transducer, using the level difference. For example, the electronic device 201 is capable of distinguishing between a touch completely closing an opening formed adjacent to the transducer and a touch partially closing the opening. Therefore, the electronic device 201 may have stored a level difference when an opening formed adjacent to the transducer is completely closed and a level difference when the opening is partially closed.

At step 1507, the electronic device 201 determines whether the difference between the levels of the first and second audio signals is within a preset range of levels. The electronic device 201 may have stored a preset range of levels. If the electronic device 201 ascertains that the difference between levels of the first and second audio signals is within a preset range of levels then, at step 1509, the electronic device 201 performs a first preset function. The first preset function may be a function for increasing/decreasing the sensitivity to an input audio signal. The first preset function may be a camera-related function (e.g., a function for entering a camera shoot mode, a function for entering a camera shoot set-up mode), a function for unlocking the lock screen of the electronic device 201, a function for muting or blocking a ringtone when an incoming call is received, etc.

On the other hand, if the electronic device 201 ascertains that the difference between levels of the first and second audio signals is not within the preset range of levels then, at step 1511, the electronic device 201 is capable of determining whether the difference between the levels of the first and second audio signals is within a second preset range of levels. The electronic device 201 may have stored a second preset range of level. If the electronic device 201 ascertains that the difference between levels of the first and second audio signals is within the second preset range of levels then, at step 1513, the electronic device 201 performs a second preset function. The second preset function may be a function for decreasing/increasing the sensitivity to an input audio signal. If the first preset function is a function for unlocking the lock screen of the electronic device 201, the second preset function may be a function for changing the unlock screen to the lock screen. If the first preset function is a function for muting or blocking a ringtone, the second preset function may be a function for re-outputting the ringtone, etc.

On the other hand, if the electronic device 201 ascertains that the difference between levels of the first and second audio signals is not within the second preset range of levels then, at step 1515, the electronic device 201 performs a third preset function. The third preset function may be a function for muting/blocking an output audio signal or a function for blocking an input audio signal. That is, the third preset function may be a function for stopping the control of the electronic device 201 using the transducer.

In various embodiments of the present disclosure, the electronic device 201 is configured to include a first transducer, a second transducer, and the processor 210. The processor 210 obtains a first audio signal via the first transducer, obtains a second audio signal via the second transducer, detects levels of the first and second audio signals, perform a first preset function if the level difference between the levels of the first and second audio signals is within a first preset range of level, and perform a second preset function if the level difference is within a second preset range of level.

The processor 210 of the electronic device 201 controls the first preset function via at least part of the second preset function.

Each of the first and second transducers of the electronic device 201 includes the speaker 282 and/or the microphone 288.

Each of the first and second functions of the electronic device 201 includes functions related to hardware, software, firmware and a combination thereof

While the present disclosure has been described with reference to various embodiments, these embodiments are merely provided to assist in a comprehensive understanding of the present disclosure and are not intended to limit the present disclosure. Therefore, it should be understood by those skilled in the art, that various changes in form and detail may be made without departing from the spirit and scope of the present disclosure, which is defined, not by the detailed description and embodiments, but by the appended claims and their equivalents.

What is claimed is:

1. An electronic device comprising:
a transducer; and
a processor that:
detects a touch of an external object which is related to the transducer, and
executes a function, based on the touch.

2. The electronic device of claim 1, wherein the transducer comprises a speaker or a microphone.

3. The electronic device of claim 2, wherein when the transducer is the speaker, the processor detects the touch of the external object based on a change in impedance at a natural resonant frequency of the speaker.

4. The electronic device of claim 2, wherein when the transducer is the microphone, the processor detects the touch of the external object, based on a detection of a change in inflow of at least one of touch noise and external noise into the microphone.

5. The electronic device of claim 1, further comprising:
a camera,
wherein the processor controls the camera to:
perform a shoot function, based on the touch, when the electronic device operates in a camera shoot mode, or
enter a camera shoot mode, based on the touch, when the electronic device operates in an idle mode.

6. The electronic device of claim 1, wherein the processor controls the transducer to input or output an audio signal, based on the touch.

7. The electronic device of claim 1, wherein the processor executes the function of at least one of an application and a firmware, based on the touch.

8. The electronic device of claim 1, wherein the external object comprises at least one of a user's body part, another electronic device, and a tool.

9. The electronic device of claim 1, wherein the processor executes the function, based on a number of touches detected during a preset period of time.

10. The electronic device of claim 1, wherein the processor executes the function, based on a preset touch pattern.

11. An electronic device comprising:
a first transducer;
a second transducer; and
a processor that:
detects a touch of an external object which is related to at least one of the first transducer and the second transducer,
performs a first preset function when the touch is related to only the first transducer, and
performs a second preset function when the touch is related only to the second transducer.

12. The electronic device of claim 11, wherein the processor performs a third preset function when the touch is related to both the first transducer and the second transducer.

13. The electronic device of claim 11, wherein the first transducer and the second transducers each comprise a speaker or a microphone.

14. The electronic device of claim 12, wherein the first preset function, the second preset function, and the third preset function each comprise at least one of a function related to hardware, a function related software, and a function related to firmware.

15. An electronic device comprising:
a first transducer;
a second transducer; and
a processor that:
obtains a first audio signal via the first transducer,
obtains a second audio signal via the second transducer,
detects a level of the first audio signal,
detects a level of the second audio signal,
performs a first preset function when a level difference between the level of the first audio signal and the level of the second audio signal is within a first preset range of levels, and
performs a second preset function if the level difference is within a second preset range of levels.

16. The electronic device of claim 15, wherein the processor controls the first preset function via at least part of the second preset function.

17. The electronic device of claim 15, wherein the first transducer and the second transducer each comprise a speaker or a microphone.

18. The electronic device of claim 15, wherein the first preset function and the second preset functions each comprise at least one of a function related to hardware, a function related to software, and a function related to firmware.
